(19) United States
(12) Patent Application Publication
(10) Pub. No.: US 2020/0063710 A1
(43) Pub. Date: Feb. 27, 2020

(54) SYSTEM AND METHODS FOR HYPER SHORT-TERM WIND POWER PREDICTION USING REAL-TIME WIND PARAMETER MEASUREMENTS

(71) Applicant: BluWave Inc., Ottawa (CA)

(72) Inventors: Mostafa Farrokhabadi, Ottawa (CA); Parham MOMTAHAN, Ottawa (CA); Devashish PAUL, Ottawa (CA)

(73) Assignee: BluWave Inc., Ottawa (CA)

(21) Appl. No.: 16/548,072

(22) Filed: Aug. 22, 2019

Related U.S. Application Data
(60) Provisional application No. 62/722,075, filed on Aug. 23, 2018.

(51) Int. Cl. F03D 7/02; F03D 7/04; F03D 17/00

(52) U.S. Cl. CPC F03D 7/02; F03D 7/048; F03D 17/00; G01P 5/00; F05B 2270/32; F05B 2270/8042; F05B 2270/20

(57) ABSTRACT

A method and system for short term wind power prediction using real time wind speed measurements is disclosed. The method includes receiving at least one real-time characteristic associated with at least one wind turbine, maintaining a database of characteristics associated with the at least one wind turbines, training a machine learning model based on one or both of the database of characteristics and the at least one characteristic, testing the accuracy of the at least one machine learning model and outputting from the machine learning model generated output data based on the training and testing data. Responsive to determining that the accuracy exceeds a predetermined value, one or both of wind speed and energy output of the at least one wind turbine can be calculated.

### CROSS REFERENCE TO RELATED APPLICATIONS

This application claims the benefit of U.S. Provisional Application No. 62/722,075, filed Aug. 23, 2018, which is incorporated by reference herein in its entirety.

### FIELD

The present disclosure relates to renewable energy power generation. More particularly, the present disclosure relates to a method and system for training, testing and deploying a machine learning model for predicting wind speed and wind power of one or more wind turbines.

### BACKGROUND

Wind energy is an important energy source. A wind farm consists of one or more wind turbines, which are operated for commercial electric power generation and which harvest wind energy and convert the harvested wind energy into electric power.

The generated electric power, i.e., the wind farm's energy output, is then distributed. It is often necessary to predict the energy output of the wind farm so that a wind farm operator can meet the varying demand for electric power. Wind farm operators may therefore require predictions of wind speed and energy output. The time period of interest for forecasts varies from hourly forecasts for dispatching and scheduling to one-day or two-day forecasts for spot market purchases and sales.

Due to the intermittent nature of a wind generator's power output, grid and micro grid operators tend to limit the maximum instantaneous penetration of wind energy resources, resulting in curtailment of wind-generated power. Accurate hyper short term prediction (in the region of seconds or minutes) of wind speed, including, wind gusts and dips, combined with adaptive control systems that adjust to these predictions, can increase the stability-margin of systems that include wind power generators as described in Y. Mohamed, and E. El-Saadany, “Adaptive Decentralized Droop Controller to Preserve Power Sharing Stability of Paralleled Inverters in Distributed Generation Microgrids” IEEE Transactions on Power Electronics 23.6 (2008): 2806-2816. Accordingly, energy grids that include one or more wind farms can set a higher limit on penetration of wind resources (i.e. energy generated from a wind farm can be accessed more readily), thus decreasing operational costs and helping reduce emissions.

Current methods of wind prediction, including statistical time-series and machine-learning techniques, can generally obtain a prediction horizon of 5 minutes or higher. Techniques based on Light Detection and Ranging (LIDAR) observation, combined with calculations of wind convection, are also used for estimation of wind speed in time intervals in the range of tens of seconds; however, these methods are expensive to implement and require complex wind convection modeling.

Additional difficulties with existing systems may be appreciated in view of the Detailed Description below.

### SUMMARY

There is disclosed a system and method to train, and test, and deploy an AI-based hyper short-term wind speed and power prediction mechanism capable of predicting wind speed and power output within a time-interval range of 5 to 30 seconds.

In one broad aspect, there is disclosed a method for predicting wind speed and energy output of at least one wind turbine, the method comprising:

receiving at least one real-time characteristic associated with the at least one wind turbines;

maintaining a database of characteristics, each characteristic being associated with at least one wind turbine;

providing a set of training data to the at least one machine learning model associated with the at least one wind turbine made up of records with each record containing one or both of the database of characteristics and the at least one real time characteristic;

testing the at least one machine learning model until the accuracy satisfies a defined threshold and extracting test data from the at least one machine model;

outputting from the at least one machine learning model generated output data based on the training data and test data; and

responsive to determining that the threshold exceeds a predetermined value, calculating one or both of wind speed and energy output of the at least one wind turbine, the calculation being based on the output of the at least one machine learning model associated with the least one wind turbine, and wherein the calculating includes calculating the wind speed and power output within a time-interval range of 5 to 30 seconds.

In another aspect, there is disclosed a system for predicting wind speed and energy output of at least one wind turbine, the system comprising:

instruments operable to measure at least one real-time characteristic associated with at least one wind turbine, a processor and a memory coupled to the processor, the memory storing computer-executable instructions that, when executed by the processor, cause the system to:

receive at least one real-time characteristic associated with the at least one wind turbines;

maintain a database of characteristics, each characteristic being associated with at least one wind turbine;

provide a set of training data to the at least one machine learning model associated with the at least one wind turbine made up of records with each record containing one or both of the database of characteristics and the at least one real time characteristic;

test the at least one machine learning model until the accuracy satisfies a defined threshold and extracting test data from the at least one machine model;

output from the at least one machine learning model generated output data based on the training data and test data; and

responsive to determining that the threshold exceeds a predetermined value, calculate one or both of wind speed and energy output of the at least one wind turbine, the calculation being based on the output of the at least one machine learning model associated with the least one wind turbine, and wherein the calculating includes calculating the wind speed and power output within a time-interval range of 5 to 30 seconds.

In some aspects, the methods of the present disclosure can be embodied in the memory of a computer program product that when executed cause a processor to perform the steps described above.

Although the present example described herein relates to a method and system for hyper short term prediction of wind speed and power output of a wind farm, it will be understood that the invention may be readily adapted for a number of applications including longer term prediction or prediction of other time series parameters associated with other time series systems, for example, solar patterns for photovoltaic systems.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a block diagrammatic view of an example wind speed and power prediction system in accordance with an embodiment of the present disclosure;

FIG. 2 is a schematic showing the arrangement of wind meters in one or more wind turbines in accordance with an embodiment of the present disclosure; and

FIG. 3 is a block diagrammatic view of an example machine learning system in accordance with an embodiment of the present disclosure.

Similar reference numerals may have been used in different figures to denote similar components.

### DETAILED DESCRIPTION

In a broad aspect, there is disclosed an AI-based system and method for training, testing, and deploying a hyper short-term wind speed and power prediction mechanism.

The present invention is described in the context of a preferred use for hyper short term prediction of wind speed and power output of a wind farm. However, it will be understood that the invention may be readily adapted for a number of applications including longer term prediction or prediction of other time series parameters associated with other time series systems, for example, solar patterns for photovoltaic systems.

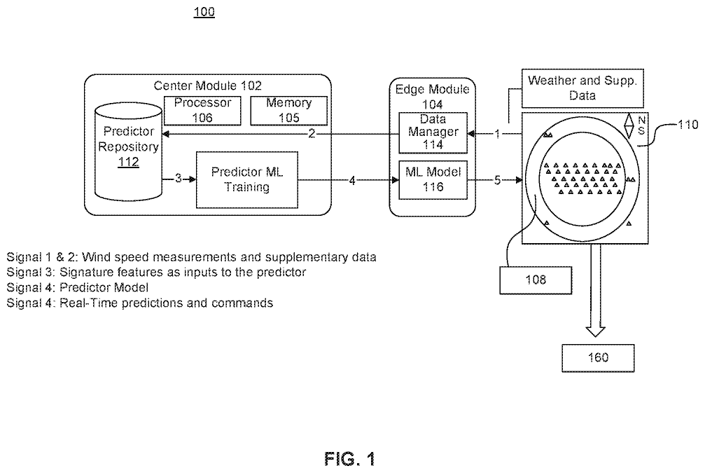

Referring now to FIG. 1, a system 100 for short term prediction of wind speed and power (energy output) is disclosed. As used herein, short term prediction refers to prediction of wind speed and power within a time interval of the next 5 to 30 seconds.

The system 100 includes a wind farm 110, center module 102 and an edge module 104. Wind farm 110 includes one or more wind turbines 120 for generating energy. The center module 102 includes a memory 105. The memory 105 stores one or more databases containing historical or measured wind speed and power generation data and/or one or more context parameters of the wind turbines 120 as described further herein. The memory 105 also includes computer-executable instructions for performing the steps of the method described herein. Centre module 102 includes a processor 106 that can be used to train and tune time-series and machine learning models for example, machine learning models 116 as further described herein. Processor 106 can also assess and remove erroneous data and ensure that the system uses only quality data. This can include the use of range tests, relational tests, and trend tests to detect erroneous data points, which can include an improperly recorded wind pattern or energy output. The processor 106 can be configured to remove erroneous data points.

The system 100 also includes a plurality of wind speed meters 108 for measuring wind speed and other data associated with the one or more wind turbines 120, e.g., anemometers, Light Detection and Ranging (LIDAR) sensors, thermometers, and barometers, located on or in each wind turbine 120 of the wind farm 110, and whose measured data are then used as input for one or more time-series and machine learning models to perform the method of hyper short term wind speed and power prediction. Each wind turbine can also include instruments that measure electric power generated by the turbine. Power generation data can be obtained by measuring energy outputs with, for example, current and voltage sensors located at each turbine 120.

Edge module 104 includes a data manager 114. In some embodiments, the data manager 114 receives weather data, wind speed measurements or other data (signal 1) from one or more wind speed meters or other sensors for example, meters 108.

In some embodiments, the context parameters of the wind turbines 120 or other features of the wind farm 110, or data obtained from the one or more meters 108 as well as supplementary data which may be accessible via memory 105 or received from the data manager 114 (signal 2), are stored in a predictor repository 112 which can then be used as inputs for a training step (signal 4) for training the one or more machine learning models 116 (signal 4) of the edge module 104 used for predicting wind speed and energy output. Data collected by the system 100 can include local wind conditions, such as wind speed, ambient temperature, wind direction, and ambient pressure, over a geographic area such as the area of the wind farm. This can be represented by values of the wind speed and direction, ambient pressure, and ambient temperature. Alternatively, the system 100 can collect any combination of weather parameters to predict wind speed and associated energy output.

The system 100 can store the data including wind speed and other data in any form, including a string of bits or an alphanumeric character string. The trained machine learning models 116 are then used to relay real time predictions and commands to the wind farm 110 or individual wind turbines 120 (signal 5).

System 100 may be configured to control one or more operable elements 160 which may be within DCC subsystem 102, or may be external to system 100. In operation, based on the machine learning model developed or propagated by system 100, one or more operable elements 160, for example, a wind turbine, may be controlled, to for example, increase or decrease the speed of the wind turbine by changing the blade pitch, increasing or decreasing power to the generator, or increasing or decreasing the resistance of the wind blade to generate more or less power.

The operable elements 160 may include an electrical element, a mechanical element, a chemical element, a chemical reaction element, and/or an electromechanical element, and/or a combination thereof. Selected one or more of the operable elements 160 can be activated to perform a task associated with one or elements of system 100. For example, the tasks completed by operable element can include increasing the speed of a wind turbine by moving one or more operable elements, changing the direction of a photovoltaic cell by activating an actuated mechanism, or activating or deactivating an entire energy generation system. In some examples, the operable element can be operated to perform other tasks such as detection/sensing of objects or environment, GPS localization, receiving road traffic volume, transmitting data, receiving data, communicating, etc. Such operations or tasks may be performed by one operable element or by a combination of operable elements. Example operable elements therefore include, as part of system 100 and the constituent subsystems 102, 104, or stand-alone, sensors, actuators, motors, lights, power controls, transceivers, transmitters, receivers, and/or communication subsystems.

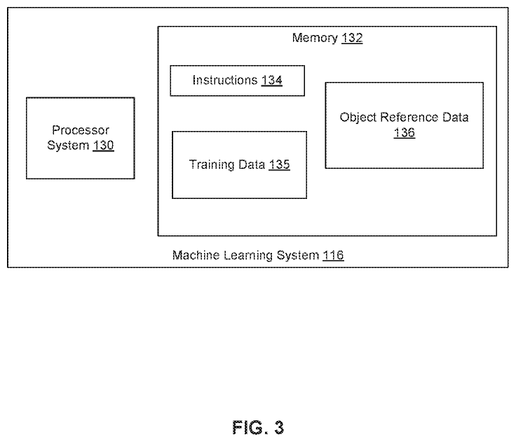

System 100 includes one or more machine learning systems 116 illustrated in FIG. 3, which perform the machine learning steps described herein.

Machine learning system 110 includes a digital processor 130 that may include one or more digital processing units. Machine learning system 116 also includes memory 132 that has one or more transient and non-transient digital memory storage elements. Computer executable instructions 134 are stored in the memory 132 that configure the processor 130 and machine learning system 116 to perform the functions as described herein.

In at least some examples, a separate training dataset 135 is also stored in memory 132 of machine learning system 116. Training dataset 135 includes a base set of data that the machine learning system 116 can build on and refine to create and update reference dataset 136 for the system 100. As described herein, training data set 135 may be obtained from one or more predictors associated with system 100. Machine learning system 116 may also use reinforcement learning or other machine learning techniques as understood in the art, including options graph based learning, to develop the training data set 135. Alternatively, training data set for the machine learning models can be obtained solely from data obtained from system 100 as described above.

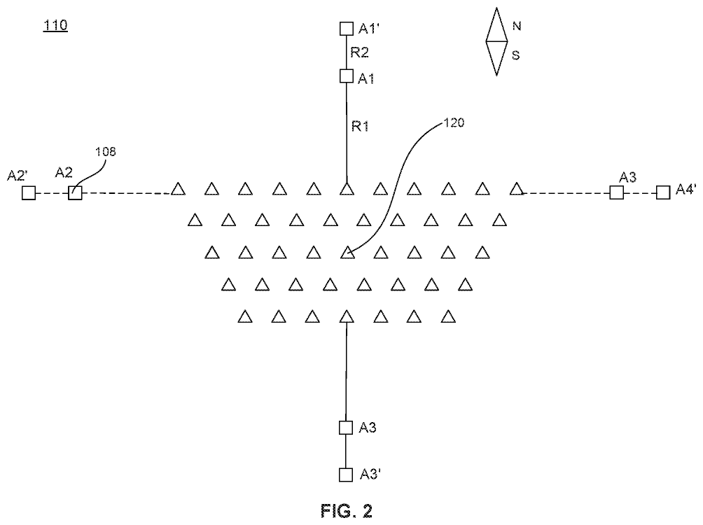

FIG. 2 is a sample schematic of a wind farm 110 showing the relative deployment and positioning of wind speed meters 108 of wind turbines 120 for wind farm 110. A plurality of meters 108 are deployed in or on one or more wind turbines 120 of wind farm 110 and then appropriately positioned as described herein. In FIGS. 2, R1 and R2 represent respective distances used to determine the distribution of the meters 108 as will be described further below. The meters 108 deployed on R1, denoted as A1, A2, A3, A4 (An) are primary meters of meters 108, and those deployed on R2, denoted as A1′, A2′, A3′, and A4′ (An′) are secondary meters of meters 108. The primary meters of meters 108 collect wind speed, and other data for the wind turbines 120 with which they are associated.

In the embodiments described herein, the secondary meters of meters 108 are optional, and depending on the operator's budget and desired performance may or may not be included in the system. The secondary meters in this embodiment, collect the same type of data as the primary meters and provide supplementary wind speed and other data that can be used as additional inputs to improve the training and prediction of the machine learning model 116. In some embodiments, this can increase the prediction accuracy of machine learning models 116. Secondary meters are supplementary and can be removed without affecting the functionality of the system 100.

In the embodiments described herein, the meters 108 (both primary and secondary meters) are installed at the wind turbine hub height. However, it will be understood that the meters may be placed at other locations either in, on, or about the wind turbine 120.

As described herein, the nominal wind direction refers to the wind direction based on which the wind farm 110 architecture is implemented (i.e. the direction which the wind turbines 120 face). For example, in FIG. 2, the nominal wind direction is from north to south. Note that the actual wind direction may deviate from this nominal direction and may be any other arbitrary direction, for example east to west. In addition, conceptually, the orientation of FIG. 1 is on an xy plane, with the y axis aligned with the nominal wind direction and the x axis being aligned in a direction orthogonal to the direction of the nominal wind direction.

As a preliminary step, the appropriate arrangement of the meters 108 on the turbines 120 of wind farm 110 is determined. An example of the arrangement of wind farm 110 is shown in FIG. 2. A method for determining a distribution of the meters 108 in accordance with an embodiment of the present disclosure is described below. The methods described below can be performed by processor 106 of centre module 102 of system 100.

On a preliminary basis, a method for determining appropriate values for R1 and R2 includes first identifying the desired prediction time-interval, denoted by n seconds. From the available and/or estimated historical wind speed database which may be stored in memory 105, the mean wind speed is identified and denoted by m m/s. R1 is the product of the time interval n and the mean wind speed m (n×m meters). This value is referred to as R1_{N}.

Next, based on the available and/or estimated historical wind speed database, the wind speed that is greater than approximately 90°/o of the wind speeds in the available wind speed database is identified and denoted by m′ m/s. R2 is then calculated as n×m′ meters.

A more advanced method for choosing R1 and R2 requires tuning efforts and costs for a number of initial wind farms or energy systems:

For the initial wind farm, implement a set of meters at incremental R1 distances, such as 0.5×R1_{N}, R1_{N}, 1.5×R1_{N}, n×R1_{N}, with n up to 10 depending on operational constraints including budget and available space. The R1 distance with the highest prediction accuracy is then determined and context parameters corresponding to that R1 distance are then extracted. The context parameters include terrain type, latitude, longitude, etc.

Step 1 is then repeated form wind farms or energy systems, until an acceptable contextual database is formed. A systematic procedure to determine m and a method of matching the context of upcoming wind farms or energy systems with one of those initial m wind farms or energy systems and choosing R1 accordingly is explained in M. Farrokhabadi, “System and Methods For Progressive Improvements To Context-Matched Machine Learning Propagation”, U.S. Provisional Application No. 62/712,456, the contents of which are hereby incorporated by reference in their entirety.

After the values of R1 and R2 are determined as described above, the respective locations of the meters 108 of system 100 are determined in accordance with the steps described below.

First, the turbine with the greatest y coordinate is identified. They coordinates can be based on longitude and latitude measurements or based on a conceptual origin point. If there are multiple turbines on the identified y coordinate, the set of their corresponding x coordinates is collected and the turbine whose x coordinate is the set median is chosen. The coordinates of the chosen turbine are denoted as (x₁, y₁). Meter A1 is then positioned at the location denoted by (x₁, y₁+R1).

Next, the turbine with the lowest x coordinate is identified. If there are multiple turbines on that x coordinate, the set of their corresponding y coordinates is selected, and the turbine with the greatest y coordinate is chosen and denoted as (x₂, y₂). Meter A2 is then positioned at location (x₂−R1, y₂).

Next, the turbine with the lowest y coordinate is identified. If there are multiple turbines with the same y coordinate, the set of their corresponding x coordinates is formed and the turbine whose x coordinate is the set median is selected. The coordinate of the chosen turbine is designated as (x₃, y₃). Meter A3 is then deployed at (x₃, y₃−R1).

Next, the turbine with the greatest x coordinate is determined. If there are multiple turbines on that x coordinate, the set of their corresponding y coordinates is formed and the turbine with the greatest y coordinate is chosen. The coordinate of the chosen turbine is denoted as (x4,y₄), and meter A4 is deployed at (x₄+R1, y₄).

The four meters 108 (A1, A2, A3, and A4) are then positioned at the determined locations and data can be collected from the meters 108 to perform the training, testing and prediction steps described herein. The method described above can be modified depending on the number of meters available. For example, if there are less than four wind speed meters available for deployment, the priority of positioning begins at A1 and continues downwards. A1 receives priority of placement as A1 is positioned upwind of the wind farm 110 considering the nominal wind direction. Meter A1 can thus act as a sentry point to measure wind conditions, thus allowing the system 100 to adapt its predictions according to any detected trends.

In embodiments in which there are greater than four wind speed meters available, the steps described above can be repeated with R1 replaced by R2 to determine the placement of the additional wind speed meters A5, A6, etc.

In the embodiments described above and shown in FIG. 2, the turbines 120 have a symmetrical distribution. However, it will be understood that the method is equally adaptive to a less symmetric, even random distribution of turbines.

Once the wind speed meters deployment phase is finished, the process of training and testing the machine learning model 116 is initiated. The first step is to form the database for the prediction technique, with the wind speed and direction measurements from the deployed wind meters, the turbines availability, time and date, and other supplementary data as the features of the dataset, and the measured wind speed at (x₁, y₁), (x₂, y₂), (x₃, y₃), (x₄, y₄), and aggregated wind farm power as the output of the dataset.

The predictor training and tuning is performed in the Center module 102 (signal 3 of FIG. 1). The performance of the resulting machine learning model 116 is evaluated using a variety of metrics including mean absolute error and mean percentage error. Once the predictor achieves the operator's desired performance or accuracy threshold, the machine learning model 116 is transferred to the Edge module 104; the real-time prediction task is then carried out in the Edge module 102 by machine learning model 116, and necessary recommendations and signals are sent out to the wind farm 110 and operable elements 160.

The predictor model represented by machine learning model 116 can be any artificial intelligence based regression model, for example, linear regression models, support vector machine learning models, and neural networks. The choice of model depends on the performance of these models for each particular wind farm/turbine 110, 120.

The system 100 can in some embodiments provide short term wind speed and associated wind power predictions based on input information, such as wind speed trends, collected at the wind farm, from regional models, and from other meters including meters 108. Machine learning model 116 associates input information, for example, wind speed, with output information, for example, future wind patterns and energy output values of the wind farm. Thus, real-time wind speeds measured by the primary and secondary meters 108, along with a window of previous measurements, are used as input data for the prediction system. Accordingly, The system at least partially bases its predictions on empirical data. Compared to predictions based entirely on numerical models, model error can be reduced.

Further, the prediction time horizon can be in the range of a few to tens of seconds. Accordingly, the output of the machine learning model 116 can be utilized to make the operable elements 160 adaptive. Operable elements 160 can include an adaptive power system control which can be controlled based on the predictive outputs of the wind turbines. For example, to avoid continuous charge and discharge, an energy storage component of wind farm 110 may not be engaged during normal variations of wind output, but may be engaged when a sudden variability is predicted in the wind turbine.

As described herein, the invention can be implemented in digital electronic circuitry, or in computer hardware, firmware, software, or in combinations of them. Systems of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. Other embodiments are possible. For example, the steps of the invention can be performed in a different order and still achieve desirable results. The system can represent data using any format and is not limited to using bit strings. The system can use any number of measurements. Furthermore, the wind speeds defining each category of wind patterns can vary depending on the type of wind turbines being used. The system can include one or more meters which may be on the wind turbines or separately in a meteorological tower or any station that includes meteorological instruments.

The embodiments of the present application described above are intended to be examples only. Those of skill in the art may make alterations, modifications and variations to the particular embodiments without departing from the intended scope of the present application. In particular, features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

The scope of the invention should not be limited by the preferred embodiments set forth in the examples but should be given the broadest interpretation consistent with the description as a whole. The claims are not to be limited to the preferred or exemplified embodiments of the invention.

1. A method for predicting wind speed and energy output of at least one wind turbine, the method comprising:
receiving at least one real-time characteristic associated with the at least one wind turbines;
maintaining a database of characteristics, each characteristic being associated with at least one wind turbine;
providing a set of training data to at least one machine learning model associated with the at least one wind turbine made up of records with each record containing one or both of the database of characteristics and the at least one real time characteristic;
testing the at least one machine learning model until an accuracy satisfies a defined threshold and extracting test data from the at least one machine model;
outputting from the at least one machine learning model generated output data based on the training data and the test data; and
responsive to determining that the threshold exceeds a predetermined value, calculating one or both of wind speed and energy output of the at least one wind turbine, the calculation being based on the output of the at least one machine learning model associated with the least one wind turbine, and wherein the calculating includes calculating the wind speed and power output within a time-interval range of 5 to 30 seconds.

2. The method of claim 1 wherein the at least one real-time characteristic includes one or more context parameters of an environment of the at least one wind turbine.

3. The method of claim 1 further comprising arranging the at least one wind turbine in a predetermined configuration.

4. The method of claim 1 wherein the predetermined configuration is a symmetric configuration about one or more of a horizontal or vertical plane.

5. The method of claim 1 wherein the at least one real-time characteristic is one or more of terrain profile, longitude, latitude, grid coordinates, elevation, contour lines, microclimate type, seasonal forecast, wind speed, and solar exposure.

6. The method of claim 1 wherein the machine learning model is a neural network.

7. The method of claim 1 further comprising controlling one or more operable elements of the at least one wind turbine based on the calculated wind speed or energy output of the at least one wind turbine.

8. A computer program product for predicting wind speed and energy output of at least one wind turbine, the computer program product comprising a computer readable medium storing program code, wherein the program code, when run on a computer, causes the computer to:
receive at least one real-time characteristic associated with the at least one wind turbines;
maintain a database of characteristics, each characteristic being associated with at least one wind turbine;
provide a set of training data to at least one machine learning model associated with the at least one wind turbine made up of records with each record containing one or both of the database of characteristics and the at least one real time characteristic;
test the at least one machine learning model until an accuracy satisfies a defined threshold and extract test data from the at least one machine model;
output from the at least one machine learning model generated output data based on the training data and the test data; and
responsive to determining that the threshold exceeds a predetermined value, calculate one or both of wind speed and energy output of the at least one wind turbine, the calculation being based on the output of the at least one machine learning model associated with the least one wind turbine, and
wherein the calculating includes calculating the wind speed and power output within a time-interval range of 5 to 30 seconds.

9. The computer program product of claim 8 wherein the at least one real-time characteristic includes one or more context parameters of an environment of the at least one wind turbine.

10. The computer program product of claim 8 wherein the predetermined configuration is a symmetric configuration about one or more of a horizontal or vertical plane.

11. The computer program product of claim 8 wherein the at least one real-time characteristic is one or more of terrain profile, longitude, latitude, grid coordinates, elevation, contour lines, microclimate type, seasonal forecast, wind speed, and solar exposure.

12. The computer program product of claim 8 wherein the machine learning model is a neural network.

13. A system for predicting wind speed and energy output of at least one wind turbine, the system comprising:
one or more instruments operable to measure at least one real-time characteristic associated with at least one wind turbine;
a processor;
a memory coupled to the processor, the memory storing computer-executable instructions that, when executed by the processor, cause the system to:
receive at least one real-time characteristic associated with the at least one wind turbines;
maintain a database of characteristics, each characteristic being associated with at least one wind turbine;
provide a set of training data to at least one machine learning model associated with the at least one wind turbine made up of records with each record containing one or both of the database of characteristics and the at least one real time characteristic;
test the at least one machine learning model until an accuracy satisfies a defined threshold and extract test data from the at least one machine model;
output from the at least one machine learning model generated output data based on the training data and the test data; and
responsive to determining that the threshold exceeds a predetermined value, calculate one or both of wind speed and energy output of the at least one wind turbine, the calculation being based on the output of the at least one machine learning model associated with the least one wind turbine, and wherein the calculating includes calculating the wind speed and power output within a time-interval range of 5 to 30 seconds.

14. The system of claim 13 further comprising one or more operable elements for controlling the at least one more wind turbine based on the calculated wind speed or energy output of the at least one wind turbine.

15. The system of claim 13 wherein the at least one real-time characteristic includes one or more context parameters of an environment of the at least one wind turbine.

16. The system of claim 13 wherein the computer-executable instructions further comprise instructions that, when executed by the processor, further cause the system to arrange the at least one wind turbine in a predetermined configuration.

17. The system of claim 13 wherein the predetermined configuration is a symmetric configuration about one or more of a horizontal or vertical plane.

18. The system of claim 13 wherein the at least one real-time characteristic is one or more of terrain profile, longitude, latitude, grid coordinates, elevation, contour lines, microclimate type, seasonal forecast, wind speed, and solar exposure.

19. The system of claim 13 wherein the machine learning model is a neural network.

20. The system of claim 13 wherein the computer-executable instructions further comprise instructions that, when executed by the processor, further cause the system to control one or more operable elements of the at least one wind turbine based on the calculated wind speed or energy output of the at least one wind turbine.
